(19) United States
(12) Patent Application Publication
(10) Pub. No.: US 2009/0018243 A1
(43) Pub. Date: Jan. 15, 2009

(54) Polyolefin-Based Building Materials

(75) Inventor: Sebastijan Bach, Achsheim (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 12/217,937

(22) Filed: Jul. 10, 2008

(30) Foreign Application Priority Data
Jul. 10, 2007 (DE) 10 2007 031 967.5

(51) Int. Cl. C08L 91/06; C08K 3/00; C08K 3/26; C08K 3/22; C08K 3/34

(52) U.S. Cl. 524/275; 524/570; 524/425; 524/424; 524/433; 524/423; 524/449; 524/451; 524/442

(57) ABSTRACT

Compositions comprising

a) one or more polyolefins which have
a ring/ball softening point in the range from 50 to 165° C.,
a melt viscosity measured at a temperature of 170° C. in the range from 20 to 40 000 mPa·s and
a glass transition temperature T_{g} of not more than −10° C. and
   b) one or more inorganic filler(s).

The compositions of the invention are suitable for producing building materials, in particular for the production of connecting elements for fastening articles to surfaces, in particular pegs.

The invention relates to the use of a composition comprising a) one or more polyolefins and b) one or more inorganic fillers as connecting element which serves to fasten an article to a building element.

It is prior art to use pegs in various embodiments as connecting elements in order to fasten articles to building elements, for example to masonry walls or other walls. The basic principle of the use of pegs is to push these into a very accurately shaped drill hole provided for this purpose and to screw a fastening screw into the peg. As a result of the spreading of the peg, this and the screw become jammed firmly in the building element. It is absolutely essential for pegs and screws to be matched to one another. If screws which have a diameter which is too small are used, they do not give sufficient grip. Screw diameters which are too large do not fit into the peg or require more force to screw the screw in. The strength of the pegs in porous building materials such as plaster or insulating material is often unsatisfactory. Frequently, e.g. in the case of plaster or masonry of poor quality, it is difficult to produce a hole which accurately fits the peg.

It is therefore an object of the present invention to provide a fastening material which avoids the abovementioned disadvantages and makes it possible, in a user-friendly manner, to achieve durable and strong fastening of an article to a building element, for example a masonry wall or other wall comprising, for example, concrete, wood or stone.

It has surprisingly been found that this object can be achieved by the use of specific hot melt compositions.

Here, the hot melt composition is injected in hot liquid form into a hollow space present or prepared in the building material. The hollow space can be produced, for example, in a customary way by means of a drilled hole. The melt fills the hollow space completely and adheres to the building material by wetting the interior wall of the hollow space. While the hot melt material solidifies and cures, a screw can be screwed into the still elastic composition. This produces an accurately fitting internal thread. The hot melt composition has solidified completely after a short time and the screw can be subjected to full loading.

It is possible to use screws of any material and of any geometry. Both metallic or wooden screws or screws of another material are possible. These can be screwed out and in again as desired without losing their ability to withstand loading. Furthermore, it is possible to use a rod-shaped mounting, even one without a screw thread, instead of screws. The principle of the invention is suitable for any type of building material, even and especially for one for which conventional pegs are unsuitable or are suitable only to a limited extent, e.g. porous masonry. A further advantage of the invention is that the hollow space accommodating the hot melt composition does not have to have, as when pegs are used, an accurately fitting geometry.

According to the invention, the compositions suitable for the hot melt material comprise a) one or more polyolefins and b) one or more inorganic filler(s).

Hot melt adhesive compositions comprising polyolefins are known from numerous documents.

Thus, EP 1 645 608 discloses polyolefins and their use as hot melt adhesives and also as binders for producing road markings.

EP 1 631 641 describes hot melt adhesive compositions comprising polyolefins which have an advantageous viscosity behavior and can therefore easily be sprayed.

WO 2001/014487 discloses hot melt adhesive compositions as construction adhesives in the production of hygiene articles.

US-A-2006/0100335 describes compositions comprising ethylene-C₃-C₂₀ copolymers or C₃-C₃₀ homopolymers or copolymers and at least 40% by weight of a filler, and also their improved processability to produce finished articles, for example films, floor coverings or wall coverings. Information about the adhesive properties of these compositions or their use as hot melt adhesive compositions is not given.

U.S. Pat. No. 6,300,398 discloses mixtures comprising ethylene copolymers, wax and a nucleating agent and also their use as hot melt adhesive composition.

As nucleating agents, mention is made of clay minerals but preference is given to organic compounds, in particular acetals. The nucleating agents are used in amounts of from 0.1 to 10% by weight, based on the polymer mixture.

In both documents, ethylene copolymers comprising ethylene and octene are used. The cohesion forces and the ultimate tensile strength/rupture strength of these olefin copolymers are relatively low.

None of the documents cited above suggests possible uses of polyolefin hot melt adhesive compositions as fastening material, in particular as pegs.

The present invention therefore provides compositions comprising
a) one or more polyolefins which have
   a ring/ball softening point in the range from 50 to 165° C.,
   a melt viscosity measured at a temperature of 170° C. in the range from 20 to 40 000 mPa·s and
   a glass transition temperature T_{g} of not more than −10° C. and
b) one or more inorganic filler(s).

The polyolefins are preferably prepared by polymerization of ethylene and propylene in the presence of metallocenes as catalyst and have a melt flow index MFI of more than 30 g/10 min, measured in accordance with ISO 1133 at a temperature of 190° C. and a load of 2.16 kg.

The compositions of the invention advantageously have a very short setting time without suffering from a decrease in adhesive and cohesive force and they also display an improved tensile strength (tensile N) and stiffness (elongation) without being brittle and also a favorable viscosity behavior. They are toxicologically and ecologically acceptable and can be handled in a simple fashion.

A further advantage of the compositions of the invention is their temperature resistance, even at temperatures below 0° C.

The inorganic fillers can be selected from among many inorganic salts and minerals. As preferred fillers, mentioned may here be made of chalks, natural milled or precipitated calcium carbonates, calcium-magnesium carbonates, calcium oxide, silicates and barite. Further suitable fillers are platelet-like fillers such as vermiculite, mica, talc or similar sheet silicates, likewise graphite or carbon black. It may be advantageous for at least part of the fillers to have been surface-treated.

Preferred embodiments of the compositions used according to the invention contain calcium carbonate as filler.

The weight ratio of the abovementioned polyolefins to inorganic filler in the compositions used according to the invention is in the range from 1:99 to 99:1, preferably from 10:90 to 90:10. In particular, the composition comprises from 61 to 89% by weight of polyolefin and from 11 to 39% by weight of filler, particularly preferably from 65 to 85% by weight of polyolefin and from 15 to 35% by weight of filler.

The compositions used according to the invention preferably contain polyolefin(s) of the type mentioned above having melt viscosities, measured at a temperature of 170° C., of from 50 to 30 000 mPa·s, particularly preferably from 100 to 20 000 mPa·s.

In a preferred embodiment, polyolefins having a number average molar mass Mₙ in the range from 500 to 20 000 g/mol, preferably in the range from 800 to 10 000 g/mol, particularly preferably in the range from 1000 to 5000 g/mol, and a weight average molar mass M_{w} in the range from 1000 to 40 000 g/mol, preferably in the range from 1600 to 30 000 g/mol, particularly preferably in the range from 2000 to 20 000 g/mol, are used. The determination of the molar mass is carried out by gel permeation chromatography.

The compositions of the invention comprise, in particular, polyolefins selected from among homopolymers of propylene and copolymers of propylene and ethylene, with the copolymers preferably comprising from 70 to 99.9% by weight, particularly preferably from 80 to 99% by weight, of one type of olefin.

In a further preferred embodiment, the compositions comprise copolymers of propylene and ethylene, with the proportion of structural units derived from propylene being from 61% by weight to 99.9% by weight, preferably from 70 to 99% by weight, particularly preferably from 80 to 95% by weight.

In a preferred embodiment, the compositions of the invention contain the component c) in addition to the components a) and b), where c) is one or more copolymer waxes which have been modified so as to be polar and are prepared by reaction of the polyolefin a) with an α,β-unsaturated carboxylic acid or derivative thereof in the presence of free-radical formers.

The copolymer waxes which have been modified so as to be polar mentioned under c) can be prepared by the method described in EP 0 941 257.

Preference is given to copolymer waxes which have been modified so as to be polar and are derived from polyolefins, preferably from polypropylene, modified by means of maleic anhydride.

The compositions of the invention comprising the components a) and b) or a), b) and c) can be used without further additives as building materials or connecting elements or can contain one or more adhesive component(s) selected from the group of resins.

Possible resins are aliphatic and cycloaliphatic or aromatic hydrocarbon resins. These can be prepared by polymerization of particular resin oil fractions obtained in the processing of petroleum. Such resins, which can, for example, be modified by hydrogenation or functionalization, are obtainable, for example, under the trade names Eastoflex, RegalREZ, Kristalex, Eastotac, Piccotac (Eastman Chemical Company) or Escorez (ExxonMobil Chemical Company). Further possible resins are polyterpene resins prepared by polymerization of terpenes, for example pinene in the presence of Friedel-Crafts catalysts, likewise hydrogenated polyterpenes, copolymers and terpolymers of natural terpenes, for example styrene-terpene or α-methylstyrene-terpene copolymers. Further possible resins are natural and modified rosin resins, in particular resin esters, glyceryl esters of tree resins, pentaerithrityl esters of tree resins and tall oil resins, and their hydrogenated derivatives and also phenol-modified pentaerithrityl esters of resins and phenol-modified terpene resins.

The abovementioned resins are present in the compositions used according to the invention either individually or in any combination in proportions by weight, based on the total weight of the composition, in the range from 0 to 90% by weight, preferably from 10 to 50% by weight, particularly preferably from 15 to 40% by weight.

In a very particularly preferred embodiment of the compositions of the invention, these contain one or more adhesive component(s) selected from among amorphous poly-alpha-olefins (=APAOs), e.g. the grades of the Vestoplast® series (Degussa) or the “Rextac” grades from Huntsman, aliphatic, cycloaliphatic or aromatic hydrocarbon resins as can be obtained, for example, under the trade name “Escorez” from Exxon Mobil, also polyisobutylene which can be obtained, for example, under the trade name “Oppanol” from BASF. It is also possible for other polyolefins, for instance low-pressure polyethyenes as are available, for example, under the name “Affinity” from Dow Chemical to be present, also high-pressure polyethylenes including those containing polar comonomers, e.g. ethylene-vinyl acetate. The total mixture of such compositions has a viscosity in the range from 100 to 10 000 mPa·s at 170° C., preferably from 120 to 9000 mPa·s at 170° C., particularly preferably from 130 to 8000 mPa·s at 170° C.

If appropriate, pigments, antioxidants, odor binders, antimicrobial substances or dyes and fragrances can also be present.

The metallocene polyolefins present in the compositions used according to the invention are prepared using metallocene compounds of the formula I as catalyst.

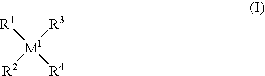

This formula also encompasses compounds of the formula Ia,

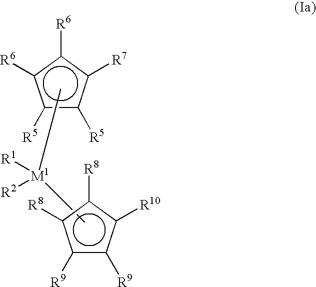

the formula Ib,

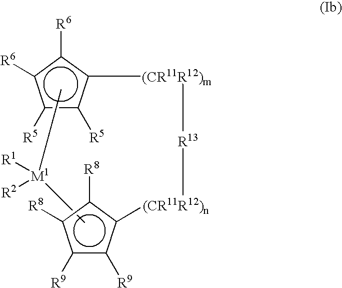

and the formula Ic.

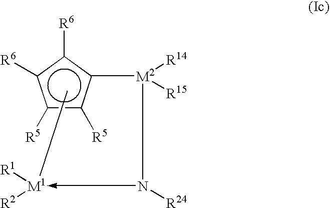

In the formulae I, Ia and Ib, M¹ is a metal of group IVb, Vb or VIb of the Periodic Table, for example titanium, zirconium, hafnium, vanadium, niobium, tantalum, chromium, molybdenum, tungsten, preferably titanium, zirconium or hafnium.

R¹ and R² are identical or different and are each a hydrogen atom, a C₁-C₁₀—, preferably C₁-C₃-alkyl group, in particular methyl, a C₁-C₁₀—, preferably C₁-C₃-alkoxy group, a C₆-C₁₀—, preferably C₆-C₈-aryl group, a C₆-C₁₀—, preferably C₆-C₈-aryloxy group, a C₂-C₁₀—, preferably C₂-C₄-alkenyl group, a C₇-C₄₀—, preferably C₇-C₁₀-arylalkyl group, a C₇-C₄₀—, preferably C₇-C₁₂-alkylaryl group, a C₈-C₄₀—, preferably C₈-C₁₂-arylalkenyl group or a halogen atom, preferably a chlorine atom.

R³ and R⁴ are identical or different, and are each a monocyclic or polycyclic hydrocarbon radical which together with the central atom M¹ can form a sandwich structure. R³ and R⁴ are preferably cyclopentadienyl, indenyl, tetrahydroindenyl, benzoindenyl or fluorenyl, with the basic molecules being able to bear additional substituents or be bridged with one another. In addition, one of the radicals R³ and R⁴ can be a substituted nitrogen atom, where R²⁴ has the meaning given for R¹⁷ and is preferably methyl, tert-butyl or cyclohexyl.

R⁵, R⁶, R⁷, R⁸, R⁹ and R¹⁰ are identical or different and are each a hydrogen atom, a halogen atom, preferably a fluorine, chlorine or bromine atom, a C₁-C₁₀—, preferably C₁-C₄-alkyl group, a C₆-C₁₀—, preferably C₆-C₈-aryl group, a C₁-C₁₀—, preferably C₁-C₃-alkoxy group, a —NR¹⁶₂, —SR¹⁶—OSiR¹⁶₃, —SiR¹⁶₃ or —PR¹⁶₂ radical, where R¹⁶ is a C₁-C₁₀—, preferably C₁-C₃-alkyl group or C₆-C₁₀—, preferably C₆-C₈-aryl group or in the case of Si- or P-containing radicals may also be a halogen atom, preferably a chlorine atom, or two adjacent radicals R⁵, R⁶, R⁷, R⁸, R⁹ or R¹⁰ together with the carbon atoms connecting them form a ring. Particularly preferred ligands are the substituted compounds of the basic radicals cyclopentadienyl, indenyl, tetrahydroindenyl, benzoindenyl or fluorenyl.

R¹³ is

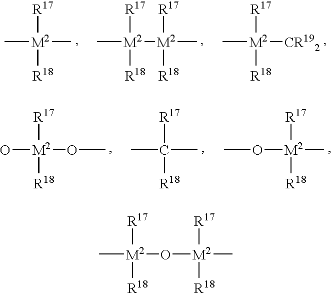

═BR¹⁷, =AIR¹⁷, —Ge—, —Sn—, —O—, —S—, ═SO, ═SO₂, ═NR¹⁷, ═CO, ═PR¹⁷ or ═P(O)R¹⁷, where R¹⁷, R¹⁸ and R¹⁹ are identical or different and are each a hydrogen atom, a halogen atom, preferably a fluorine, chlorine or bromine atom, a C₁-C₃₀—, preferably C₁-C₄-alkyl group, in particular a methyl group, a C₁-C₁₀-fluoroalkyl group, preferably a CF₃ group, a C₆-C₁₀-fluoroaryl group, preferably a pentafluorophenyl group, a C₆-C₁₀—, preferably C₆-C₈-aryl group, a C₁-C₁₀—, preferably C₁-C₄-alkoxy group, in particular a methoxy group, a C₂-C₁₀—, preferably C₂-C₄-alkenyl group, a C₇-C₄₀—, preferably C₇-C₁₀-aralkyl group, a C₈-C₄₀—, preferably C₈-C₁₂-arylalkenyl group or a C₇-C₄₀—, preferably C₇-C₁₂-alkylaryl group, or R¹⁷ and R¹⁸ or R¹⁷ and R¹⁹ together with the atoms connecting them form a ring.

M² is silicon, germanium or tin, preferably silicon or germanium. R¹³ is preferably ═CR¹⁷R¹⁸, ═SiR¹⁷R¹⁸, ═GeR¹⁷R¹⁸, —O—, —S—, ═SO, ═PR¹⁷ or ═P(O)R¹⁷.

R¹¹ and R¹² are identical or different and have the meanings given for R¹⁷. m and n are identical or different and are each zero, 1 or 2, preferably zero or 1, with m plus n being zero, 1 or 2, preferably zero or 1.

R¹⁴ and R¹⁵ have the meanings of R¹⁷ and R¹⁸.

Specific examples of suitable metallocenes are:
bis(1,2,3-trimethylcyclopentadienyl)zirconium dichloride,
bis(1,2,4-trimethylcyclopentadienyl)zirconium dichloride,
bis(1,2-dimethylcyclopentadienyl)zirconium dichloride,
bis(1,3-dimethylcyclopentadienyl)zirconium dichloride,
bis(1-methylindenyl)zirconium dichloride,
bis(1-n-butyl-3-methylcyclopentadienyl)zirconium dichloride,
bis(2-methyl-4,6-di-1-propylindenyl)zirconium dichloride,
bis(2-methylindenyl)zirconium dichloride,
bis(4-methylindenyl)zirconium dichloride,
bis(5-methylindenyl)zirconium dichloride,
bis(alkylcyclopentadienyl)zirconium dichloride,
bis(alkylindenyl)zirconium dichloride,
bis(cyclopentadienyl)zirconium d chloride,
bis(indenyl)zirconium dichloride,
bis(methylcyclopentadienyl)zirconium dichloride,
bis(n-butylcyclopentadienyl)zirconium dichloride,
bis(octadecylcyclopentadienyl)zirconium dichloride,
bis(pentamethylcyclopentadienyl)zirconium dichloride,
bis(trimethylsilylcyclopentadienyl)zirconium dichloride,
biscyclopentadienyldibenzylzirconium,
biscyclopentadienyldimethylzirconium,
bistetrahydroindenylzirconium dichloride,
dimethylsilyl-9-fluorenylcyclopentadienylzirconium dichloride,
dimethylsilylbis-1-(2,3,5-trimethylcyclopentadienyl)zirconium dichloride,
dimethylsilylbis-1-(2,4-dimethylcyclopentadienyl)zirconium dichloride,
dimethylsilylbis-1-(2-methyl-4,5-benzoindenyl)zirconium dichloride,
dimethylsilylbis-1-(2-methyl-4-ethylindenyl)zirconium dichloride,
dimethylsilylbis-1-(2-methyl-4-i-propylindenyl)zirconium dichloride,
dimethylsilylbis-1-(2-methyl-4-phenylindenyl)zirconium dichloride,
dimethylsilylbis-1-(2-methylindenyl)zirconium dichloride,
dimethylsilylbis-1-(2-methyltetrahydroindenyl)zirconium dichloride,
dimethylsilylbis-1-indenylzirconium dichloride,
dimethylsilylbis-1-indenyldimethylzirconium,
dimethylsilyl-bis-1-tetrahydroindenylzirconium dichloride,
diphenylmethylene-9-fluorenylcyclopentadienylzirconium dichloride,
diphenylsilylbis-1-indenylzirconium dichloride,
ethylenebis-1-(2-methyl-4,5-benzoindenyl)zirconium dichloride,
ethylenebis-1-(2-methyl-4-phenylindenyl)zirconium dichloride,
ethylenebis-1-(2-methyltetrahydroindenyl)zirconium dichloride,
ethylenebis-1-(4,7-dimethylindenyl)zirconium dichloride,
ethylenebis-1-indenylzirconium dichloride,
ethylenebis-1-tetrahydroindenylzirconium dichloride,
indenylcyclopentadienylzirconium dichloride isopropylidene(1-indenyl)(cyclopentadienyl)zirconium dichloride,
isopropylidene(9-fluorenyl)(cyclopentadienyl)zirconium dichloride,
phenylmethylsilylbis-1-(2-methylindenyl)zirconium dichloride,
and also the alkyl or aryl derivatives of these metallocene dichlorides.

To activate the single-site catalyst systems, suitable cocatalysts are used. Suitable cocatalysts for metallocenes of the formula I are organoaluminum compounds, in particular aluminoxanes, or else aluminum-free systems such as R²ₓNH₄₋ₓBR²¹₄, R²⁰ₓPH₄₋ₓBR²¹₄, R²⁰₃CBR²¹₄ or BR²¹₃. In these formulae, x is from 1 to 4, the radicals R²⁰ are identical or different, preferably identical, and are each C₁-C₁₀-alkyl or C₆-C₁₈-aryl or two radicals R²⁰ together with the atoms connecting them form a ring, and the radicals R²¹ are identical or different, preferably identical, and are each C₆-C₁₈-aryl which may be substituted by alkyl, haloalkyl or fluorine. In particular, R²⁰ is ethyl, propyl, butyl or phenyl and R²¹ is phenyl, pentafluorophenyl, 3,5-bistrifluoromethylphenyl, mesityl, xylyl or tolyl.

A third component is frequently also necessary to maintain protection against polar catalyst poisons. Organoaluminum compounds such as triethylaluminum, tributylaluminum and others and also mixtures of these are suitable for this purpose.

Depending on the process, it is also possible to use supported single-site catalysts. Preference is give to catalyst systems in which the residual content of support material and cocatalyst do not exceed a concentration of 100 ppm in the product.

Processes for preparing such polyolefins are described, for example, in the prior art, e.g. EP-A-0 321 851, EP-A-0 321 852, EP-A-0 384 264, EP-A-0 571 882 and EP-A-0 890 584.

The compositions of the invention are suitable for use for producing building materials, in particular for producing connecting elements for fastening articles to surfaces, e.g. pegs. Since the setting times of the compositions are very low and are in the range of <12 seconds, preferably in the range from 0.1 to 10 seconds, particularly preferably in the range from 0.5 to 8 seconds, especially preferably in the range from 1 to 5 seconds, the connecting elements can be mounted in a simple fashion within a very short time.

Compositions having a filler content below 40% by weight, based on the compositions, are particularly advantageous. The extension capability or the stiffness of the composition, determined as the elongation in %, is ideal for the intended purpose, i.e. a good stiffness is achieved without the composition being brittle and rupturing and breaking when screws are screwed in. The compositions having very high proportions of filler display elongation values of 0% and have a high tendency to form cracks.

### EXAMPLES

The following examples illustrate the invention but do not restrict it to the embodiments specifically mentioned. Percentages are, unless indicated otherwise, percentages by weight.

The melt viscosities were determined in accordance with DIN 53019 using a rotational viscometer, the dropping points were determined in accordance with ASTM D3954, the ring/ball softening points were determined in accordance with ASTM D3104. The weight average molar mass M_{w} and the number-average molar mass Mₙ were determined by gel permeation chromatography at a temperature of 135° C. in 1,2-dichlorobenzene.

The setting time is determined by adhesively bonding 2 paper strips to one another and measuring the time within which the paper strips can be separated without damage and without fibers being torn out.

The tensile strength (tensile N) is determined by subjecting a test specimen having a thickness of 500 μm to a tensile force and measuring the force at which the test specimen ruptures.

The elongation (in %) is the extensibility to rupture of the test specimen.

The Licocene PP 2602® TP propylene polymer used according to the invention was prepared by the process disclosed in the prior art in EP 0 384 264.

| Formulation 1 (F1) | |
|---|---|
| Licocene PP 2602 ® TP | 30% |
| Snowcal 70 | 65% |
| Licocene PP MA 6252 TP | 5% |
| Comparative formulation 1 (C-F1) | |
| Licocene PP 2602 ® TP | 85.7% |
| Licocene PP MA 6252 TP | 14.3% |
| Formulation 2 (F2) | |
| Licocene PP 2602 ® TP | 76.3% |
| Snowcal 70 | 11% |
| Licocene PP MA 6252 TP | 13.7% |
| Formulation 3 (F3) | |
| Licocene PP 2602 ® TP | 62.3% |
| Snowcal 70 | 39% |
| Licocene PP MA 6252 TP | 9.7% |

General method of production: the polymers used are melted at 200° C.

The filler is subsequently added while stirring and stirring is continued until the total amount of filler has been taken up by the polymer.

TABLE 2
Formulation (F1 to F3) and comparative formulation (C-F1) with
resulting viscosities, setting times, tensile strengths (tensile N)
and elongation

| | Viscosity, | | | |
|---|---|---|---|---|
| | 180° C. | | | |
| F, CF | [mPa · s] | set time [sec.] | tensile N [N] | elongation [%] |
| F1 | 11160 | 3 | 2.8 | 0 |
| C-F1 | 3870 | 15 | 1.6 | 600 |
| F2 | 3810 | 10 | 0.9 | 32 |
| F3 | 6350 | 5 | 1.3 | 13 |

The test results show a very large reduction in the setting time due to the filler Snowcal 70 (CaCO₃), and a significant increase in the tensile strength and/or the stiffness. In the case of compositions having a high filler content (F1), the elongation was measured as 0%, which indicates high brittleness of the composition.

Characterization of the commercial products used:

Licocene PP MA 6252 TP: polypropylene, grafted with maleic anhydride, Clariant Produkte (Deutschland) GmbH.

Licocene PP 2602® TP: propylene polymer, Clariant Produkte (Deutschland) GmbH

Snowcal 70: calcium carbonate, Omya

1. A composition comprising
a) one or more polyolefins wherein the one or more polyolefins have
a ring/ball softening point in the range from 50 to 165° C.,
a melt viscosity measured at a temperature of 170° C. in the range from 20 to 40 000 mPa·s and
a glass transition temperature T_{g} of not more than −10° C. and
b) one or more inorganic fillers.

2. The composition as claimed in claim 1, wherein the one or more polyolefins have been prepared by polymerization of ethylene and propylene in the presence of metallocenes as catalyst.

3. The composition as claimed in claim 1, wherein the one or more polyolefins have a melt flow index MFI of more than 30 g/10 min, measured in accordance with ISO 1133 at a temperature of 190° C. and a load of 2.16 kg.

4. The composition as claimed in claim 1, wherein the one or more organic fillers are selected from the group of chalks, natural milled or precipitated calcium carbonates, calcium-magnesium carbonates, calcium oxide, silicates, barite, graphite, carbon black, vermiculite, mica, talc and sheet silicates.

5. The composition as claimed in claim 1, wherein the weight ratio of the one or more polyolefins to the one or more inorganic fillers is in the range from 1:99 to 99:1.

6. The composition as claimed in claim 1, comprising from 61 to 89% by weight of the one or more polyolefins and from 11 to 39% by weight of the one or more organic fillers.

7. The composition as claimed in further comprising a component c), wherein c) is one or more copolymer waxes modified so as to be polar and are prepared by reaction of the one or more Polyolefins with an α,β-unsaturated carboxylic acid or derivative thereof in the presence of free-radical formers.

8. The composition as claimed in claim 1, further comprising from 0 to 90% by weight of aliphatic, cycloaliphatic or aromatic hydrocarbon resins, based on the total weight of the composition.

9. The composition as claimed in claim 8, having a viscosity in the range from 100 to 10 000 mPa·s at 170° C.

10. A building material, connecting element for fastening articles to surfaces or a peg comprising a composition as claimed in claim 1.
